(19) United States
(12) Patent Application Publication
(10) Pub. No.: US 2023/0169680 A1
(43) Pub. Date: Jun. 1, 2023

(54) BEIJING BAIDU NETCOM SCIENCE TECHNOLOGY CO., LTD.

(71) Applicant: BEIJING BAIDU NETCOM SCIENCE TECHNOLOGY CO., LTD., Beijing (CN)

(72) Inventors: Chenxu Zhao, Beijing (CN); Zhihao Wang, Beijing (CN)

(73) Assignee: BEIJING BAIDU NETCOM SCIENCE TECHNOLOGY CO., LTD., Beijing (CN)

(21) Appl. No.: 18/057,954

(22) Filed: Nov. 22, 2022

(30) Foreign Application Priority Data
Nov. 30, 2021 (CN) 202111450133.5

(51) Int. Cl. G06T 7/73; G06V 20/62; G06V 30/10; G01C 21/00

(52) U.S. Cl. CPC G06T 7/73; G06V 20/63; G06V 30/10; G01C 21/3811; G06T 2207/30244

(57) ABSTRACT

A positioning method, a method for generating a visual map and an apparatus thereof includes: obtaining a current parking space number corresponding to a parking space image; obtaining a three-dimensional (3D) coordinate and a 3D pose of the current parking space number under a world coordinate system based on the current parking space number and a visual map, in which the visual map is generated based on current parking space numbers; obtaining a first conversion matrix from a camera coordinate system to a current parking space number coordinate system, in which the current parking space number coordinate system is generated based on the current parking space number; and determining a 3D coordinate and a 3D pose of a camera under the world coordinate system based on the first conversion matrix and the 3D coordinate and 3D pose of the current parking space number.

### CROSS REFERENCE TO RELATED APPLICATION

This application is based on and claims priority to Chinese patent application No. 202111450133.5, filed on Nov. 30, 2022, the entire content of which is hereby introduced into this application by reference for all purposes.

### TECHNICAL FIELD

The disclosure relates to the field of Artificial Intelligence (AI) technologies such as computer vision, optical character recognition, intelligent traffic and augmented reality, in particular to a positioning method, a positioning apparatus, a method for generating a visual map, and an apparatus for generating a visual map.

### BACKGROUND

Positioning plays an increasingly important role in people's daily life. For example, functions such as driving navigation and shop searching are all realized by the positioning technologies. Since GPS signals, Bluetooth signals or WIFI signals are easily affected by surrounding environment, stable positioning is difficult to achieve in the case of weak signals. As an emerging positioning solution, visual positioning is popular and widely used in scientific research, industrial and commercial fields, for example, a cleaning robot and a VR room viewing system that may achieve efficient panoramic navigation. The visual positioning technologies may be divided into positioning technologies based on a visual map and positioning technologies without prior maps.

### SUMMARY

The disclosure provides a positioning method, a positioning apparatus, a method for generating a visual map.

According to a first aspect of the disclosure, a positioning method is provided. The method includes: obtaining a current parking space number corresponding to a parking space image; obtaining a three-dimensional (3D) coordinate and a 3D pose of the current parking space number under a world coordinate system based on the current parking space number and a visual map, in which the visual map is generated based on parking space numbers; obtaining a first conversion matrix from a camera coordinate system to a current parking space number coordinate system, in which the current parking space number coordinate system is generated based on the current parking space number; and determining a 3D coordinate and a 3D pose of a camera under the world coordinate system based on the first conversion matrix and the 3D coordinate and the 3D pose of the current parking space number.

According to a second aspect of the disclosure, a method for generating a visual map is provided. The method includes: determining 3D coordinates of a plurality of parking space numbers under a world coordinate system based on a parking space number plan view; determining 3D poses of the plurality of parking space numbers under the world coordinate system based on the parking space number plan view; and generating the visual map based on the 3D coordinates and 3D poses of the plurality of parking space numbers.

According to a third aspect of the disclosure, a positioning apparatus is provided. The apparatus includes: a first obtaining module, a second obtaining module, a third obtaining module and a first determining module. The first obtaining module is configured to obtain a current parking space number corresponding to a parking space image. The second obtaining module is configured to obtain a 3D coordinate and a 3D pose of the current parking space number under a world coordinate system based on the current parking space number and a visual map, in which the visual map is generated based on parking space numbers. The third obtaining module is configured to obtain a first conversion matrix from a camera coordinate system to a current parking space number coordinate system, in which the current parking space number coordinate system is generated based on the current parking space number. The first determining module is configured to determine a 3D coordinate and a 3D pose of a camera under the world coordinate system based on the first conversion matrix and the 3D coordinate and the 3D pose of the current parking space number.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of a positioning method according to a first embodiment of the disclosure.

FIG. 2 is a schematic diagram of a parking space image according to an embodiment of the disclosure.

FIG. 3 is a flowchart of a positioning method according to a second embodiment of the disclosure.

FIG. 4 is a schematic diagram of a scene of setting a preset position vector from a camera to a parking space number according to an embodiment of the disclosure.

FIG. 5 is a flowchart of a positioning method according to a third embodiment of the disclosure.

FIG. 6 is a flowchart of a positioning method according to a fourth embodiment of the disclosure.

FIG. 7 is a schematic diagram of a parking space number plan view according to an embodiment of the disclosure.

FIG. 8 is a schematic diagram of a parking space number coordinate system according to an embodiment of the disclosure.

FIG. 9 is a flowchart of a method for generating a visual map according to a first embodiment of the disclosure.

FIG. 10 is a flowchart of a method for generating a visual map according to a second embodiment of the disclosure.

FIG. 11 is a flowchart of a method for generating a visual map according to a third embodiment of the disclosure.

FIG. 12 is a flowchart of a method for generating a visual map according to a fourth embodiment of the disclosure.

FIG. 13 is a block diagram of a positioning apparatus according to a first embodiment of the disclosure.

FIG. 14 is a block diagram of a positioning apparatus according to a second embodiment of the disclosure.

FIG. 15 is a block diagram of an apparatus for generating a visual map according to a first embodiment of the disclosure.

FIG. 16 is a block diagram of an apparatus for generating a visual map according to a second embodiment of the disclosure.

FIG. 17 is a block diagram of an electronic device for implementing a method of an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

AI is a technical science that studies and develops theories, methods, technologies and application systems for simulating, extending and expanding human intelligence. Currently, AI technology is widely used due to advantages of high degree of automation, high accuracy and low cost.

Computer vision, also known as machine vision, is a simulation for biological vision using computers and related devices, which refers to machine vision that uses cameras and computers instead of human eyes to identify, track and measure targets, and further perform graphic processing, to make images processed by the computer more suitable for human eye observation or transmission to instruments for inspection.

Optical Character Recognition (OCR) refers to a process of scanning text data and then analyzing image files to obtain text and layout information. Indicators for measuring performances of the OCR system include rejection rate, false recognition rate, recognition speed, user interface friendliness, product stability, ease of use and feasibility, etc.

Intelligent Traffic System (ITS), also known as intelligent transportation system, is an integrated transportation system capable of ensuring safety, increasing efficiency, improving environment and saving energy that is formed by effectively and comprehensively applying advanced science and technology (e.g., information technology, computer technology, data communication technology, sensor technology, electronic control technology, automatic control theory, operations research and AI) to transportation, service control and vehicle manufacturing, to strengthen a connection between vehicles, roads and users.

Augmented Reality (AR) is a technology that calculates respective positions and angles of camera images in real time and adds the corresponding images, which uses a variety of technical means to superimpose computer-generated virtual objects or non-geometric information on real objects onto a scene of a real world, to enhance the real world.

A positioning method, a positioning apparatus, a method for generating a visual map, and an apparatus for generating a visual map according to an embodiments of the disclosure are described below with reference to the accompanying drawings.

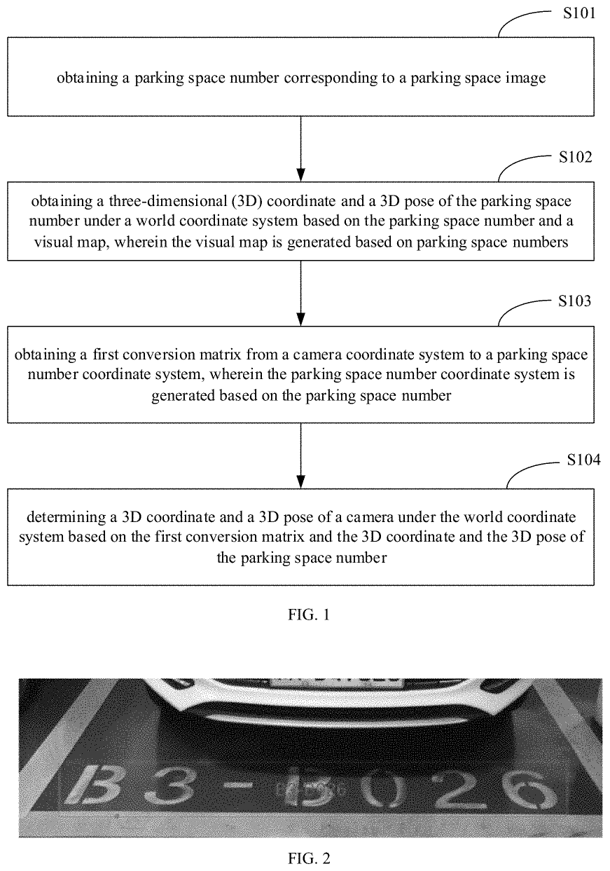

FIG. 1 is a flowchart of a positioning method according to a first embodiment of the disclosure.

As illustrated in FIG. 1, the positioning method according to an embodiment of the disclosure may include the following blocks.

At block S101, a current parking space number corresponding to a parking space image is obtained.

In detail, an executive actor of the positioning method according to an embodiment of the disclosure may be a positioning apparatus according to an embodiment of the disclosure. The positioning apparatus may be a hardware device having data information processing capability and/or necessary software for driving the hardware device to operate. Optionally, the executive actor may include a workstation, a server, a computer, a user terminal and other devices. The user terminal includes but not limited to a mobile phone, a computer, an intelligent voice interaction device, a smart home appliance, and a vehicle terminal. An embodiment of the disclosure takes a parking lot as an example to describe an implementation of the positioning method of an embodiment of the disclosure in the parking lot scene.

In an embodiment of the disclosure, the current parking space number corresponding to a parking space in the parking space image is obtained from the parking space image captured by a user through a photographing device such as a camera of a mobile terminal. As illustrated in FIG. 2, a vehicle is parked in a certain parking space of a parking lot, and a parking space number is marked at one end of the parking space close to a road, the current parking space number corresponding to the parking space is obtained from the parking space image with the parking space number through OCR technology.

At block S102, a 3D coordinate and a 3D pose of the current parking space number under a world coordinate system are obtained based on the current parking space number and a visual map. The visual map is generated based on parking space numbers.

For a parking lot that includes a plurality of parking spaces, relevant information such as locations of the parking spaces is displayed on a plan view (such as a CAD drawing) of the parking lot. In some embodiments, the relevant information corresponding to the parking space numbers is obtained from the plan view according to the parking space numbers, and then the visual map is generated according to the relevant information.

In some implementations, the 3D coordinate and the 3D pose of the current parking space number under the world coordinate system are obtained according to the current parking space number obtained from the parking space image and the visual map. The world coordinate system can be regarded as a coordinate system with adding a Z axis on the basis of an origin coordinate system of the plan view.

At block S103, a first conversion matrix from a camera coordinate system to a current parking space number coordinate system is obtained, and the current parking space number coordinate system is generated based on the current parking space number.

In some embodiments, the current parking space number coordinate system may be generated with coordinates of the current parking space number as an origin of the coordinate system. The camera coordinate system may be generated with a light spot of the camera that the user takes the parking space image as an origin of the coordinate system. The first conversion matrix from the camera coordinate system to the current parking space number coordinate system may be obtained based on the generated camera coordinate system and the current parking space number coordinate system, and a coordinate under the current parking space number coordinate system corresponding to a position point under the camera coordinate system may be determined according to the first conversion matrix. For example, the coordinate of a position point P under the camera coordinate system is (X_{C}, Y_{C}, Z_{C}), and the coordinate (X_{O}, Y_{O}, Z_{O}) of a space point P under the current parking space number coordinate system can be obtained according to the coordinate (X_{C}, Y_{C}, Z_{C}) and the first conversion matrix.

At block S104, a 3D coordinate and a 3D pose of a camera under the world coordinate system are determined based on the first conversion matrix and the 3D coordinate and the 3D pose of the current parking space number.

In an embodiment of the disclosure, the 3D coordinate and the 3D pose of the camera under the world coordinate system may be obtained based on the first conversion matrix and the 3D coordinate and 3D pose of the current parking space number under the world coordinate system.

For example, the 3D coordinate and 3D pose of the current parking space number under the world coordinate system (that is, a position and an orientation of the current parking space number under the world coordinate system, represented by a matrix To2w) are determined based on the current parking space number obtained from the parking space image and the visual map. The 3D coordinate and the 3D pose of the camera under the world coordinate system are obtained according to the matrix To2w and the first conversion matrix Tc2o. Thus, positioning of 6-DOF may be realized, that is, Tc2w=To2w×Tc2o.

In conclusion, according to the positioning method of an embodiment of the disclosure, the current parking space number corresponding to the parking space image is obtained. The 3D coordinate and the 3D pose of the current parking space number under the world coordinate system are obtained based on the current parking space number and the visual map, in which the visual map is generated based on the parking space numbers. The first conversion matrix from the camera coordinate system to the current parking space number coordinate system is obtained, in which the current parking space number coordinate system is generated based on the current parking space number. The 3D coordinate and the 3D pose of the camera under the world coordinate system are determined based on the first conversion matrix and the 3D coordinate and the 3D pose of the current parking space number. Therefore, a positioning effect is enhanced without excessive reliance on visual features and by avoiding influences of factors such as environment and high repetitiveness of textures. The camera (that is, the user's location) may be positioned according to the first conversion matrix, the visual map of the parking lot scene and the current parking space number obtained from the parking space image. The method is easy to rapidly deploy and implement, and has low maintenance costs, which facilitates commercial implementation in batches.

FIG. 3 is a flowchart of a positioning method according to a second embodiment of the disclosure.

As illustrated in FIG. 3, on the basis of an embodiment shown in FIG. 1, the positioning method of an embodiment of the disclosure may include the following blocks.

At block S301, a current parking space number corresponding to a parking space image is obtained.

At block S302, a 3D coordinate and a 3D pose of the current parking space number under a world coordinate system are obtained based on the current parking space number and a visual map. The visual map is generated based on parking space numbers.

In detail, block S103 in the above embodiment may include the following blocks S303-S304.

At block S303, a rotation matrix from a camera coordinate system to a current parking space number coordinate system is obtained.

In an embodiment of the disclosure, a principal axis of the camera coordinate system may be rotated to a direction of a main axis of the corresponding parking space number coordinate system according to the rotation matrix. Therefore, rotation angles for respective principal axes of the camera coordinate system when converting from the camera coordinate system to the current parking space number coordinate system may be obtained, and the rotation matrix may be generated based on the plurality of rotation angles. The rotation matrix may be regarded as a rotation component from the camera coordinate system to the current parking space number coordinate system.

In some embodiments, for a vector under the camera coordinate system, a direction of the vector under the current parking space number coordinate system may be obtained according to the rotation matrix (represented by R).

At block S304, the first conversion matrix is determined based on the rotation matrix and a preset position vector from the camera to the current parking space number.

In an embodiment of the disclosure, the position vector from the camera to the current parking space number may be preset as required, and the position vector may be regarded as a translation component from the camera coordinate system to the current parking space number coordinate system. For example, the camera coordinate system and the current parking space number coordinate system may be moved according to the position vector, to enable origins of the two coordinate systems to be coincided.

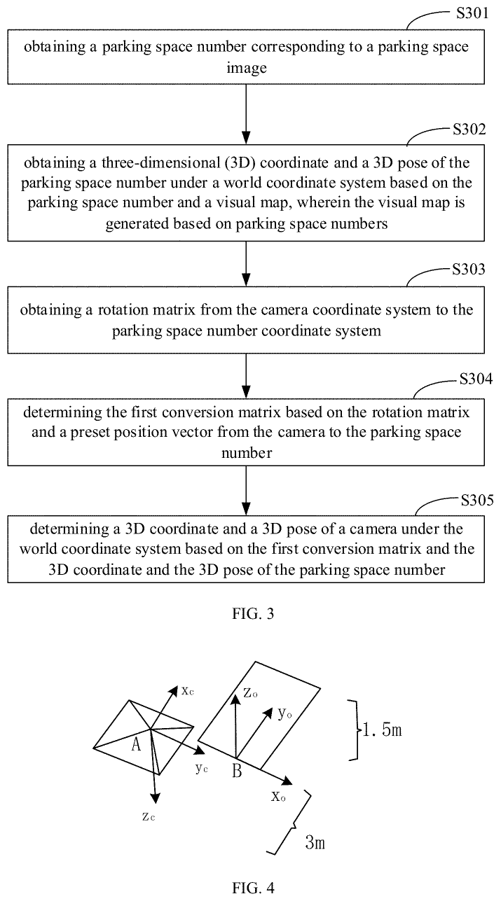

For example, as illustrated in FIG. 4, the preset position from the camera to the current parking space number is set as follows: a height of the camera (point A) relative to the current parking space number (point B) is 1.5 m, a yaw angle of the camera relative to the current parking space number is 0, a projection of the camera on the ground is at a position of −3 m along a y axis of the current parking space number coordinate system. The position vector T from the camera to the current parking space number may be obtained according to a vector [symbol] , and the position vector may also be understood as an offset vector.

In some embodiments, the first conversion matrix

$$[ \begin{matrix}R & T \\ \vec{0} & 1\end{matrix} ]$$

may be determined according to the position vector T and the rotation matrix R.

At block S305, a 3D coordinate and a 3D pose of the camera under the world coordinate system are determined based on the first conversion matrix and the 3D coordinate and the 3D pose of the current parking space number.

The blocks S301-S302 are similar to the blocks S101-S102 in the foregoing embodiment, and the block S305 is similar to the block S104 in the foregoing embodiment, which will not be repeated here.

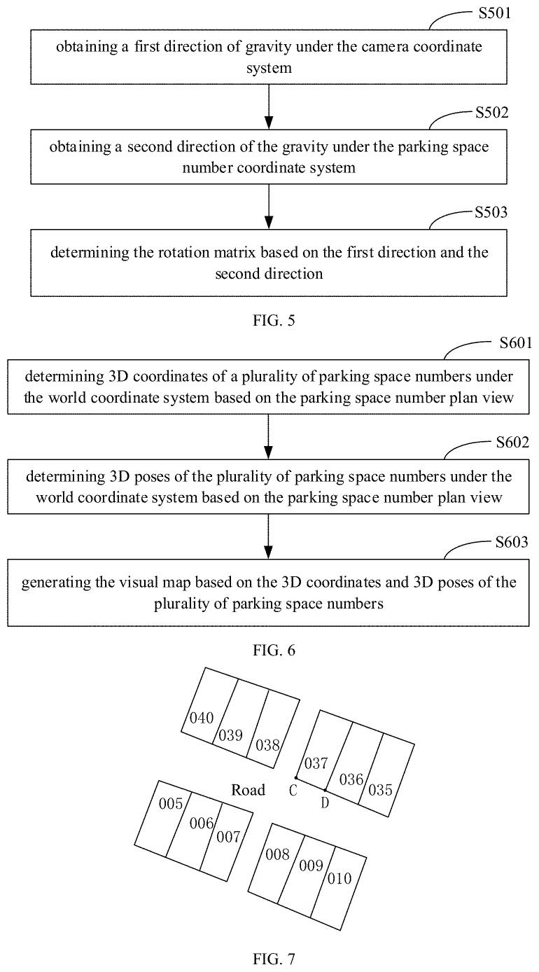

Further, on the basis of any of the above-mentioned embodiments, as shown in FIG. 5, block S303 “obtaining a rotation matrix from the camera coordinate system to the current parking space number coordinate system” may include the following blocks.

At block S501, a first direction of gravity under the camera coordinate system is obtained.

In an embodiment of the disclosure, a direction of gravity under the camera coordinate system, namely the first direction, may be obtained through an accelerometer in a mobile device. The first direction may be represented by a vector V1 under the camera coordinate system.

At block S502, a second direction of the gravity under the current parking space number coordinate system is obtained.

In the embodiment of the disclosure, a direction of gravity under the current parking space number coordinate system, namely the second direction, may be calculated based on the current parking space number coordinate system. The second direction is represented by a vector V2 under the current parking space number coordinate system.

At block S503, the rotation matrix is determined based on the first direction and the second direction.

In an embodiment of the disclosure, the rotation matrix may be calculated according to the vector V1 corresponding to the first direction and the vector V2 corresponding to the second direction. That is, a rotation matrix from the vector V1 under the camera coordinate system to the vector V2 under the current parking space number coordinate system may be calculated.

Therefore, the first conversion matrix between the two coordinate systems may be obtained based on the rotation matrix and the preset position vector, and the coordinate of the camera under the current parking space number coordinate system may be determined based on the first conversion matrix.

In a possible implementation, the visual map in the above embodiments may be generated according to the plan view information corresponding to the parking space numbers in the parking space number plan view.

On the basis of the foregoing embodiments, as shown in FIG. 6, the positioning method of an embodiment of the disclosure may further include a process of generating the visual map which may include the following blocks.

At block S601, 3D coordinates of a plurality of parking space numbers under the world coordinate system are determined based on the parking space number plan view.

In an embodiment of the disclosure, an origin of the plan view is regarded as an origin of the world coordinate system, to the world coordinate system generate. The 3D coordinates of the parking space numbers in the parking space number plan view are determined based on the world coordinate system.

As a feasible implementation, when generating a visual map of a parking lot on the ground, two-dimensional (2D) coordinates of the plurality of parking space numbers in an origin coordinate system of the plan view are determined, that is, values of (x, y). On the basis, the 3D coordinate of each parking space number under the world coordinate system may be obtained by adding 0 on a Z axis. For an underground parking lot, a coordinate value of the Z axis may be determined according to an actual value of a distance from the parking lot to the ground.

In some embodiments, the 2D coordinates of the parking space numbers in the origin coordinate system of the plan view may be determined in the following manner. As illustrated in FIG. 7, in the parking space number plan view, each parking space number corresponds to a parking space frame. For each parking space number, 2D coordinates of two corner points of the corresponding parking space frame are obtained (e.g., for a parking space frame corresponding to a parking space No. 037 in FIG. 7, two corner points closer to a road are a corner point C and a corner point D). A 2D coordinate of a midpoint of a line segment between the two corner points are obtained according to the 2D coordinates of the two corner points, and the 2D coordinate of the midpoint of the line segment between the two corner points is determined as the 2D coordinate of the parking space number corresponding to the parking space frame.

At block S602, 3D poses of the plurality of parking space numbers under the world coordinate system are determined based on the parking space number plan view.

In some embodiments, the parking space number coordinate system corresponding to the parking space number is generated according to the parking space number plan view, and the 3D poses of the parking space number under the world coordinate system is determined according to the parking space number coordinate system and the world coordinate system.

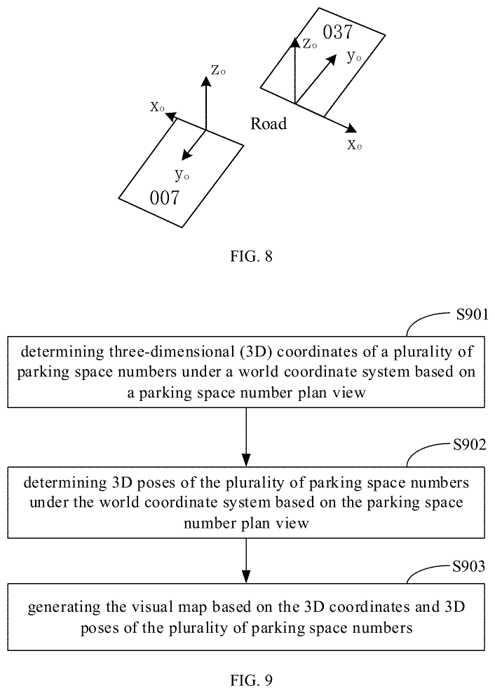

For example, as illustrated in FIG. 8, each parking space number coordinate system, such as a parking space number coordinate system corresponding to a parking space No. 007 and a parking space number coordinate system corresponding to a parking space No. 037 shown in FIG. 8, is generated by taking the coordinate point of the parking space number as an origin point, a direction from left to right that is parallel to the road and facing the parking space number as an X axis, a direction from a side of the parking space closer to the road to the other side away from the road as a Y axis, a direction from the ground to the sky is a Z axis. For each of the plurality of parking space numbers, a translation component and a rotation component from the parking space number coordinate system corresponding to parking space number to the world coordinate system are determined, and the 3D pose of each of the parking space numbers under the world coordinate system, that is, an orientation of the parking space number under the world coordinate system, is determined according to the translation component and rotation component.

At block S603, the visual map is generated based on the 3D coordinates and the 3D poses of the plurality of parking space numbers.

In an embodiment of the disclosure, a mapping relation between the parking space numbers and the corresponding 3D coordinates and 3D poses is generated according to the 3D coordinates and the 3D poses of the parking space numbers. The location and orientation information corresponding to the parking space numbers are aggregated to generate the visual map.

Therefore, the parking space number coordinate system may be generated according to the parking space information corresponding to each parking space number in the parking space number plan view, such as locations of the two corner points of each parking space frame, arrangement distribution information of respective parking spaces. The 3D poses of the parking space numbers in the world coordinate system are determined according to the parking space number coordinate systems and the world coordinate system, thereby enhancing a degree of freedom of positioning and providing more accurate positioning information.

In conclusion, according to the positioning method of an embodiment of the disclosure, the current parking space number corresponding to the parking space image is obtained. The 3D coordinate and the 3D pose of the current parking space number under the world coordinate system are obtained based on the current parking space number and the visual map, in which the visual map is generated based on the parking space numbers. The first conversion matrix from the camera coordinate system to the current parking space number coordinate system is obtained, in which the current parking space number coordinate system is generated based on the current parking space number. The 3D coordinate and the 3D pose of the camera under the world coordinate system is determined based on the first conversion matrix and the 3D coordinate and the 3D pose of the current parking space number. Therefore, a positioning effect may be enhanced without excessive reliance on visual features and by avoiding influences of factors such as environment and high repetitiveness of textures. The first conversion matrix may be determined based on the rotation matrix and the preset position vector from the camera to the current parking space number. The camera (that is, the user's location) may be positioned according to the first conversion matrix, the visual map of the parking lot and the current parking space number obtained from the parking space image. The method is easy to rapidly deploy and implement, and has low maintenance costs, which facilitates commercial implementation in batches.

In order to implement the above embodiments, the disclosure also provides a method for generating a visual map. FIG. 9 is a flowchart of a method for generating a visual map according to a first embodiment of the disclosure.

As illustrated in FIG. 9, the method for generating the visual map may include the following blocks.

At block S901, 3D coordinates of a plurality of parking space numbers under a world coordinate system are determined based on a parking space number plan view.

In an embodiment, an executive actor of the method for generating the visual map in an embodiment of the disclosure may be an apparatus for generating a visual map of an embodiment of the disclosure. The apparatus may be a hardware device having data information processing capability and/or necessary software for driving the hardware device to operate. Optionally, the executive actor may include a workstation, a server, a computer, a user terminal and other devices. The user terminal may include but not limited to a mobile phone, a computer, an intelligent voice interaction device, a smart home appliance, and a vehicle terminal, etc.

At block S902, 3D poses of the plurality of parking space numbers under the world coordinate system are determined based on the parking space number plan view.

At block S903, the visual map is generated based on the 3D coordinates and the 3D poses of the plurality of parking space numbers.

It should be noted that, the method for generating the visual map in an embodiment of the disclosure is similar to that in the above embodiment, which will not be repeated here.

In conclusion, according to the method for generating the visual map according to an embodiment of the disclosure, the 3D coordinates of the plurality of parking space numbers under the world coordinate system are determined according to the parking space number plan view. The 3D poses of the plurality of parking space numbers under the world coordinate system are determined based on the parking space number plan view. The visual map is generated based on the 3D coordinates and the 3D poses of the plurality of parking space numbers. Therefore, in an embodiment of the disclosure, the visual map is generated based on the parking space number plan view without collecting large amounts of data and images of the parking lot scene, thus saving costs and avoiding influences of environmental factors such as lighting on the generation of the visual map.

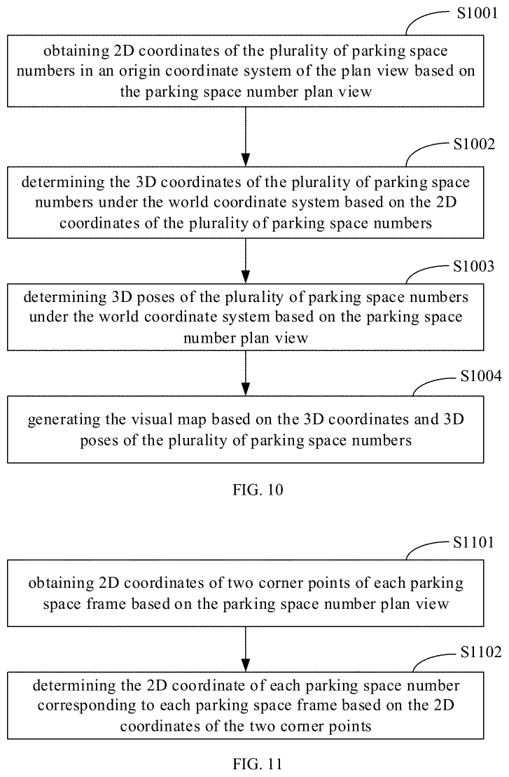

FIG. 10 is a flowchart of a method for generating a visual map according to a second embodiment of the disclosure.

As illustrated in FIG. 10, on the basis of the above embodiment, the method for generating the visual map may include the following blocks.

The above-mentioned block S901 may specifically include blocks S1001-S1002.

At block S1001, 2D coordinates of the plurality of parking space numbers in an origin coordinate system of the plan view are determined based on the parking space number plan view.

At block S1002, the 3D coordinates of the plurality of parking space numbers under the world coordinate system are determined based on the 2D coordinates of the plurality of parking space numbers.

At block S1003, 3D poses of the plurality of parking space numbers under the world coordinate system are determined based on the parking space number plan view.

At block S1004, the visual map is generated based on the 3D coordinates and the 3D poses of the plurality of parking space numbers.

In detail, the blocks S1003-S1004 are similar to the blocks S902-S903 in the foregoing embodiment, and the method for generating the visual map in an embodiment of the disclosure is similar to that in the foregoing embodiment, which will not be repeated here.

On the basis of the above-mentioned embodiment, as shown in FIG. 11, the block S1001, “obtaining the 2D coordinates of the plurality of parking space numbers in the origin coordinate system of the plan view based on the parking space number plan view” may include the following blocks.

At block S1101, 2D coordinates of two corner points of each parking space frame are determined based on the parking space number plan view.

At block S1102, the 2D coordinate of each parking space number corresponding to each parking space frame is determined based on the 2D coordinates of the two corner points.

It should be noted that, the method for generating the visual map in an embodiment of the disclosure is similar to that in the above embodiment, which will not be repeated here.

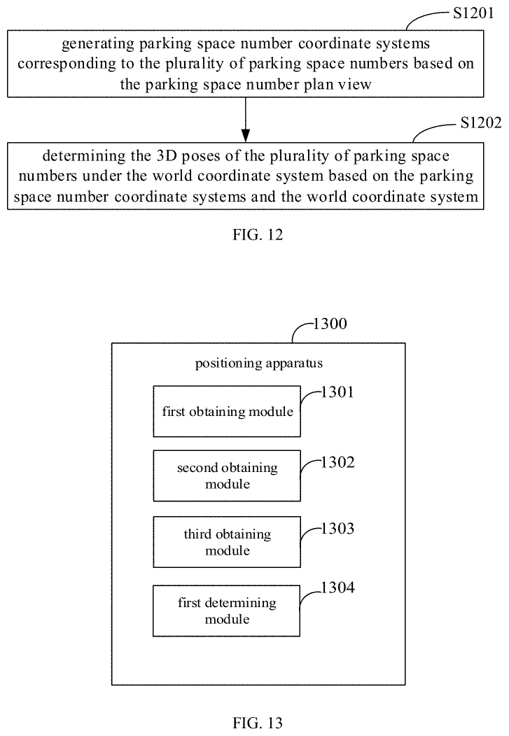

On the basis of the above embodiments, as shown in FIG. 12, block S1003 “determining the 3D poses of the plurality of parking space numbers under the world coordinate system based on the parking space number plan view” include the following blocks.

At block S1201, the parking space number coordinate systems corresponding to the plurality of parking space numbers are generated based on the parking space number plan view.

At block S1202, the 3D poses of the plurality of parking space numbers under the world coordinate system are determined based on the parking space number coordinate systems and the world coordinate system.

It should be noted that, the method for generating the visual map in an embodiment of the disclosure is similar to the contents in the above-mentioned embodiment, which will not be repeated here.

In conclusion, according to the method for generating the visual map according to an embodiment of the disclosure, the 3D coordinates of the plurality of parking space numbers under the world coordinate system are determined according to the parking space number plan view. The 3D poses of the plurality of parking space numbers under the world coordinate system are determined based on the parking space number plan view. The visual map is generated based on the 3D coordinates and the 3D poses of the plurality of parking space numbers. Therefore, in an embodiment of the disclosure, the visual map is generated based on the parking space number plan view without collecting large amounts of data and images of the parking lot scene, thus saving costs and avoiding influences of environmental factors such as lighting on the generation of the visual map.

FIG. 13 is a block diagram of a positioning apparatus according to a first embodiment of the present disclosure.

As illustrated in FIG. 13, a positioning apparatus 1300 in an embodiment of the disclosure may include a first obtaining module 1301, a second obtaining module 1302, a third obtaining module 1303 and a first determining module 1304.

The first obtaining module 1301 is configured to obtain a current parking space number corresponding to a parking space image.

The second obtaining module 1302 is configured to obtain a 3D coordinate and a 3D pose of the current parking space number under a world coordinate system based on the current parking space number and a visual map, in which the visual map is generated based on parking space numbers.

The third obtaining module 1303 is configured to obtain a first conversion matrix from a camera coordinate system to a current parking space number coordinate system, in which the current parking space number coordinate system is generated based on the current parking space number.

The first determining module 1304 is configured to determine a 3D coordinate and a 3D pose of a camera under the world coordinate system based on the first conversion matrix and the 3D coordinate and the 3D pose of the current parking space number.

It should be noted that the above explanations on embodiments of the positioning method are also applicable for the positioning apparatus of embodiments of the disclosure, and the specific process will not be repeated here.

In conclusion, with the positioning apparatus of the embodiments of the disclosure, the current parking space number corresponding to the parking space image is obtained. The 3D coordinate and the 3D pose of the current parking space number under the world coordinate system are obtained based on the current parking space number and the visual map, in which the visual map is generated based on the parking space numbers. The first conversion matrix from the camera coordinate system to the current parking space number coordinate system is obtained, in which the current parking space number coordinate system is generated based on the current parking space number. The 3D coordinate and the 3D pose of the camera under the world coordinate system is determined based on the first conversion matrix and the 3D coordinate and the 3D pose of the current parking space number. Therefore, a positioning effect may be enhanced without excessive reliance on visual features and by avoiding influences of factors such as environment and high repetitiveness of textures. The camera (that is, the user's location) may be positioned according to the first conversion matrix, the visual map of the parking lot scene and the current parking space number obtained from the parking space image. The method is easy to rapidly deploy and implement and has low maintenance costs, which facilitates commercial implementation in batches.

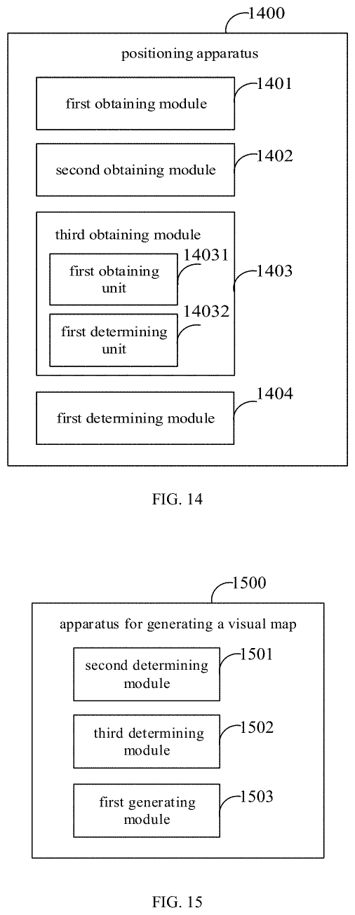

FIG. 14 is a block diagram of a positioning apparatus according to a second embodiment of the disclosure.

As illustrated in FIG. 14, a positioning apparatus 1400 in an embodiment of the disclosure may include a first obtaining module 1401, a second obtaining module 1402, a third obtaining module 1403 and a first determining module 1404.

The first obtaining module 1401 has a similar structure and function to the first obtaining module 1301 in the above embodiment, the second obtaining module 1402 has a similar structure and function to the second obtaining module 1302 in the above embodiment, the third obtaining module 1403 has a similar structure and function to the third obtaining module 1303 in the above embodiment, and the first determining module 1404 has a similar structure and function to the first determining module 1304 in the above embodiment.

The third obtaining module 1403 may further include: a first obtaining unit 14031 and a first determining unit 14032. The first obtaining unit 14031 is configured to obtain a rotation matrix from the camera coordinate system to the current parking space number coordinate system. The first determining unit 14032 is configured to determine the first conversion matrix based on the rotation matrix and a preset position vector from the camera to the current parking space number.

The first obtaining unit 1401 may include a first obtaining sub-unit, a second obtaining sub-unit and a first determining sub-unit. The first obtaining sub-unit is configured to obtain a first direction of gravity under the camera coordinate system. The second obtaining sub-unit is configured to obtain a second direction of the gravity under the current parking space number coordinate system. The first determining sub-unit is configured to determine the rotation matrix based on the first direction and the second direction.

The first obtaining unit 1401 may further include a detecting unit, configured to performing OCR detection on the parking space image, to obtain the current parking space number.

The visual map is generated based on plan view information of the parking space numbers in a parking space number plan view.

The positioning apparatus 1400 may further include a fourth determining module, a fifth determining module and a second generating module. The fourth determining module is configured to determine 3D coordinates of a plurality of parking space numbers under a world coordinate system based on a parking space number plan view. The fifth determining module is configured to determine 3D poses of the plurality of parking space numbers under the world coordinate system based on the parking space number plan view. The second generating module is configured to generate the visual map based on the 3D coordinates and the 3D poses of the plurality of parking space numbers.

The fourth determining module includes a second obtaining unit and a second determining unit. The second obtaining unit is configured to obtain 2D coordinates of the plurality of parking space numbers in an origin coordinate system of the plan view based on the parking space number plan view. The second determining unit is configured to determine the 3D coordinates of the plurality of parking space numbers under the world coordinate system based on the 2D coordinates of the plurality of parking space numbers.

The second obtaining unit may include a third obtaining sub-unit and a second determining sub-unit. The third obtaining sub-unit is configured to obtain 2D coordinates of two corner points of each parking space frame based on the parking space number plan view. The second determining sub-unit is configured to determine the 2D coordinate of each parking space number corresponding to each parking space frame based on the 2D coordinates of the two corner points.

The fifth determining module may include a first generating unit and a third determining unit. The first generating unit is configured to generate parking space number coordinate systems corresponding to the plurality of parking space numbers based on the parking space number plan view. The third determining unit is configured to determine the 3D poses of the plurality of parking space numbers under the world coordinate system based on the parking space number coordinate systems and the world coordinate system.

In conclusion, with the positioning apparatus of embodiments of the disclosure, the current parking space number corresponding to the parking space image is obtained. The 3D coordinate and the 3D pose of the current parking space number under the world coordinate system are obtained based on the current parking space number and the visual map, in which the visual map is generated based on the parking space numbers. The first conversion matrix from the camera coordinate system to the current parking space number coordinate system is obtained, in which the current parking space number coordinate system is generated based on the current parking space number. The 3D coordinate and the 3D pose of the camera under the world coordinate system is determined based on the first conversion matrix and the 3D coordinate and the 3D pose of the current parking space number. Therefore, a positioning effect is enhanced without excessive reliance on visual features and by avoiding influences of factors such as environment and high repetitiveness of textures. The first conversion matrix is determined based on the rotation matrix and the preset position vector from the camera to the current parking space number. The camera (that is, the user's location) may be positioned according to the first conversion matrix, the visual map of the parking lot scene and the current parking space number obtained from the parking space image. The method is easy to rapidly deploy and implement, and has low maintenance costs, which facilitates commercial landing in batches.

FIG. 15 is a block diagram of an apparatus for generating a visual map according to a first embodiment of the disclosure.

As illustrated in FIG. 15, an apparatus for generating a visual map 1500 according to an embodiment of the disclosure may include a second determining module 1501, a third determining module 1502, and a first generating module 1503.

The second determining module 1501 is configured to determine 3D coordinates of a plurality of parking space numbers under a world coordinate system based on a parking space number plan view.

The third determining module 1502 is configured to determine 3D poses of the plurality of parking space numbers under the world coordinate system based on the parking space number plan view.

The first generating module 1503 is configured to generate the visual map based on the 3D coordinates and the 3D poses of the plurality of parking space numbers.

It should be noted that the above explanations on embodiments of the method for generating the visual map are also applicable for the apparatus for generating the visual map of embodiments of the disclosure, and the specific process will not be repeated here.

In conclusion, with the apparatus for generating a visual map according to the embodiment of the disclosure, the 3D coordinates of the plurality of parking space numbers under the world coordinate system are determined according to the parking space number plan view. The 3D poses of the plurality of parking space numbers under the world coordinate system are determined based on the parking space number plan view. The visual map is generated based on the 3D coordinates and 3D poses of the plurality of parking space numbers. The visual map is generated based on the parking space number plan view without collecting large amounts of data and images of the parking scene, thus saving costs and avoiding influences of environmental factors such as lighting on the generation of the visual map.

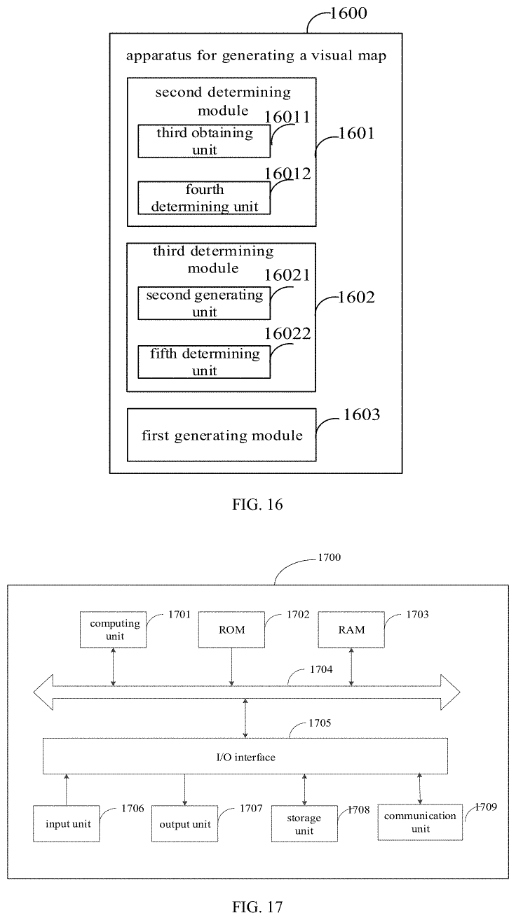

FIG. 16 is a block diagram of an apparatus for generating a visual map according to a second embodiment of the disclosure.

As illustrated in FIG. 16, an apparatus for generating a visual map 1600 according to an embodiment of the disclosure may include a second determining module 1601, a third determining module 1602, and a first generating module 1603.

The second determining module 1601 has a similar structure and function to the second determining module 1501 in the above embodiment, the third determining module 1602 has a similar structure and function to the third determining module 1502 in the above embodiment, the first generating module 1603 has a similar structure and function to the first generating module 1503 in the above embodiment.

The second determining module 1601 may include a third obtaining unit 16011 and a fourth determining unit 16012. The third obtaining unit 16011 is configured to obtain 2D coordinates of the plurality of parking space numbers in an origin coordinate system of the plan view based on the parking space number plan view. The fourth determining unit 16012 is configured to determine the 3D coordinates of the plurality of parking space numbers under the world coordinate system based on the 2D coordinates of the plurality of parking space numbers.

The third obtaining unit 16011 may include a fourth obtaining subunit and a third determining subunit. The fourth obtaining subunit is configured to obtain 2D coordinates of two corner points of each parking space frame based on the parking space number plan view. The third determining subunit is configured to determine the 2D coordinate of each parking space number corresponding to each parking space frame based on the 2D coordinates of the two corner points.

The third determining module 1602 may include a second generating unit 16021 and a fifth determining unit 16022. The second generating unit 16021 is configured to generate the parking space number coordinate systems corresponding to the plurality of parking space numbers based on the parking space number plan view. The fifth determining unit 16022 is configured to determine the 3D poses of the plurality of parking space numbers under the world coordinate system based on the parking space number coordinate systems and the world coordinate system.

In conclusion, with the apparatus for generating the visual map according to an embodiment of the disclosure, the 3D coordinates of the plurality of parking space numbers under the world coordinate system are determined according to the parking space number plan view. The 3D poses of the plurality of parking space numbers under the world coordinate system are determined based on the parking space number plan view. The visual map is generated based on the 3D coordinates and the 3D poses of the plurality of parking space numbers. The visual map is generated based on the parking space number plan view without collecting large amounts of data and images of the parking lot scene, thus saving costs and avoiding influences of environmental factors such as lighting on the generation of the visual map.

In the technical solution of the disclosure, collection, storage, use, processing, transmission, provision and disclosure of the user's personal information involved are all in compliance with relevant laws and regulations, and do not violate public order and good customs.

According to embodiments of the disclosure, the disclosure provides an electronic device, and a readable storage medium and a computer program product.

FIG. 17 is a block diagram of an illustrative electronic device 1700 for implementing embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 17, the electronic device 1700 includes: a computing unit 1701 performing various appropriate actions and processes based on computer programs stored in a read-only memory (ROM) 1702 or computer programs loaded from the storage unit 1708 to a random access memory (RAM) 1703. In the RAM 1703, various programs and data required for the operation of the device 1700 are stored. The computing unit 1701, the ROM 1702, and the RAM 1703 are connected to each other through a bus 1704. An input/output (I/O) interface 1705 is also connected to the bus 1704.

Components in the device 1700 are connected to the I/O interface 1705, including: an inputting unit 1706, such as a keyboard, a mouse; an outputting unit 1707, such as various types of displays, speakers; a storage unit 1708, such as a disk, an optical disk; and a communication unit 1709, such as network cards, modems, and wireless communication transceivers. The communication unit 1709 allows the device 1700 to exchange information/data with other devices through a computer network such as the Internet and/or various telecommunication networks.

The computing unit 1701 may be various general-purpose and/or dedicated processing components with processing and computing capabilities. Some examples of computing unit 1701 include, but are not limited to, a CPU, a graphics processing unit (GPU), various dedicated AI computing chips, various computing units that run machine learning model algorithms, and a digital signal processor (DSP), and any appropriate processor, controller and microcontroller. The computing unit 1701 executes the various methods and processes described above, such as the positioning method shown in FIG. 1 to FIG. 8, or the method for generating a visual map shown in FIG. 9 to FIG. 12. For example, in some embodiments, the above method may be implemented as a computer software program, which is tangibly contained in a machine-readable medium, such as the storage unit 1708. In some embodiments, part or all of the computer program may be loaded and/or installed on the device 1700 via the ROM 1702 and/or the communication unit 1709. When the computer program is loaded on the RAM 1703 and executed by the computing unit 1701, one or more steps of the method described above may be executed. Alternatively, in other embodiments, the computing unit 1701 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a block-chain.

The embodiments of the disclosure provide a computer program product. When the computer programs in the product are executed by a processor, the steps of the positioning method or the method for generating the visual map in embodiments is implemented.

It should be understood that various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A positioning method, comprising:
obtaining a current parking space number corresponding to a parking space image;
obtaining a three-dimensional (3D) coordinate and a 3D pose of the current parking space number under a world coordinate system based on the current parking space number and a visual map, wherein the visual map is generated based on parking space numbers;
obtaining a first conversion matrix from a camera coordinate system to a current parking space number coordinate system, wherein the current parking space number coordinate system is generated based on the current parking space number; and
determining a 3D coordinate and a 3D pose of a camera under the world coordinate system based on the first conversion matrix and the 3D coordinate and the 3D pose of the current parking space number.

2. The method of claim 1, wherein obtaining the first conversion matrix comprises:
obtaining a rotation matrix from the camera coordinate system to the current parking space number coordinate system; and
determining the first conversion matrix based on the rotation matrix and a preset position vector from the camera to the current parking space number.

3. The method of claim 2, wherein obtaining the rotation matrix from the camera coordinate system to the current parking space number coordinate system comprises:
obtaining a first direction of gravity under the camera coordinate system;
obtaining a second direction of the gravity under the current parking space number coordinate system; and
determining the rotation matrix based on the first direction and the second direction.

4. The method of claim 1, wherein obtaining the current parking space number corresponding to the parking space image comprises:
obtaining the current parking space number by performing an optical character recognition detection on the parking space image.

5. The method of claim 1, wherein the visual map is generated based on plan view information of the parking space numbers in a parking space number plan view.

6. The method of claim 5, further comprising:
determining 3D coordinates of a plurality of parking space numbers under the world coordinate system based on the parking space number plan view;
determining 3D poses of the plurality of parking space numbers under the world coordinate system based on the parking space number plan view; and
generating the visual map based on the 3D coordinates and 3D poses of the plurality of parking space numbers.

7. The method of claim 6, wherein determining the 3D coordinates of the plurality of parking space numbers under the world coordinate system based on the parking space number plan view comprises:
obtaining two-dimensional (2D) coordinates of the plurality of parking space numbers in an origin coordinate system of the plan view based on the parking space number plan view; and
determining the 3D coordinates of the plurality of parking space numbers under the world coordinate system based on the 2D coordinates of the plurality of parking space numbers.

8. The method of claim 7, wherein obtaining the 2D coordinates of the plurality of parking space numbers in the origin coordinate system of the plan view based on the parking space number plan view comprises:
obtaining 2D coordinates of two corner points of each parking space frame based on the parking space number plan view; and
determining the 2D coordinate of each parking space number corresponding to each parking space frame based on the 2D coordinates of the two corner points.

9. The method of claim 6, wherein determining the 3D poses of the plurality of parking space numbers under the world coordinate system based on the parking space number plan view comprises:
generating parking space number coordinate systems corresponding to the plurality of parking space numbers based on the parking space number plan view; and
determining the 3D poses of the plurality of parking space numbers under the world coordinate system based on the parking space number coordinate systems and the world coordinate system.

10. A method for generating a visual map, comprising:
determining three-dimensional (3D) coordinates of a plurality of parking space numbers under a world coordinate system based on a parking space number plan view;
determining 3D poses of the plurality of parking space numbers under the world coordinate system based on the parking space number plan view; and
generating the visual map based on the 3D coordinates and 3D poses of the plurality of parking space numbers.

11. The method of claim 10, wherein determining the 3D coordinates of the plurality of parking space numbers under the world coordinate system based on the parking space number plan view comprises:
obtaining 2D coordinates of the plurality of parking space numbers in an origin coordinate system of the plan view based on the parking space number plan view; and
determining the 3D coordinates of the plurality of parking space numbers under the world coordinate system based on the 2D coordinates of the plurality of parking space numbers.

12. The method of claim 11, wherein obtaining the 2D coordinates of the plurality of parking space numbers in the origin coordinate system of the plan view based on the parking space number plan view comprises:
obtaining 2D coordinates of two corner points of each parking space frame based on the parking space number plan view; and
determining the 2D coordinate of each parking space number corresponding to each parking space frame based on the 2D coordinates of the two corner points.

13. The method of claim 10, wherein determining the 3D poses of the plurality of parking space numbers under the world coordinate system based on the parking space number plan view comprises:
generating parking space number coordinate systems corresponding to the plurality of parking space numbers based on the parking space number plan view; and
determining the 3D poses of the plurality of parking space numbers under the world coordinate system based on the parking space number coordinate systems and the world coordinate system.

14. A positioning apparatus, comprising:
at least one processor; and
a memory communicatively coupled to the at least one processor; wherein,
the memory stores instructions executable by the at least one processor, when the instructions are executed by the at least one processor, the at least one processor is configured to:
obtain a current parking space number corresponding to a parking space image;
obtain a three-dimensional (3D) coordinate and a 3D pose of the current parking space number under a world coordinate system based on the current parking space number and a visual map, wherein the visual map is generated based on parking space numbers;
obtain a first conversion matrix from a camera coordinate system to a current parking space number coordinate system, wherein the current parking space number coordinate system is generated based on the current parking space number; and
determine a 3D coordinate and a 3D pose of a camera under the world coordinate system based on the first conversion matrix and the 3D coordinate and the 3D pose of the current parking space number.

15. The apparatus of claim 14, wherein the at least one processor is configured to:
obtain a rotation matrix from the camera coordinate system to the current parking space number coordinate system; and
determine the first conversion matrix based on the rotation matrix and a preset position vector from the camera to the current parking space number.

16. The apparatus of claim 15 wherein the at least one processor is configured to:
obtain a first direction of gravity under the camera coordinate system;
obtain a second direction of the gravity under the current parking space number coordinate system; and
determine the rotation matrix based on the first direction and the second direction.

17. The apparatus of claim 1, wherein the at least one processor is configured to:
obtain the current parking space number by performing an optical character recognition detection on the parking space image.

18. The apparatus of claim 1, wherein the visual map is generated based on plan view information of the parking space numbers in a parking space number plan view.

19. The apparatus of claim 18, wherein the at least one processor is configured to:
determine 3D coordinates of a plurality of parking space numbers under the world coordinate system based on the parking space number plan view;
determine 3D poses of the plurality of parking space numbers under the world coordinate system based on the parking space number plan view; and
generate the visual map based on the 3D coordinates and 3D poses of the plurality of parking space numbers.
